(19) United States
(12) Patent Application Publication
(10) Pub. No.: US 2024/0094890 A1
(43) Pub. Date: Mar. 21, 2024

(54) VIDEO EDITING UI CONTROL METHOD AND APPARATUS

(71) Applicant: KINEMASTER CORPORATION, Seoul (KR)

(72) Inventor: Ha Young RYU, Seoul (KR)

(21) Appl. No.: 18/254,237

(22) PCT Filed: Nov. 30, 2021
(86) PCT No.: PCT/KR2021/017893

§ 371 Date: May 24, 2023

(30) Foreign Application Priority Data
Nov. 30, 2020 (KR) 10-2020-0164922
Nov. 30, 2021 (KR) 10-2021-0168731

(51) Int. Cl. G06F 3/04847; G06F 3/04886; G11B 27/031; G11B 27/36

(52) U.S. Cl. CPC G06F 3/04847; G06F 3/04886; G11B 27/031; G11B 27/36; G06F 2203/04803

(57) ABSTRACT

Disclosed herein a video editing UI control method. The method for video editing UI control includes visualizing and displaying an editing UI on a display device, checking user input information based on user touch input provided through the display device, checking the user input information and checking a deletion element based on the user input information, checking a type of the selected deletion element, and checking an alternative element in consideration of time information of the selected deletion element and controlling and applying the alternative element.

### TECHNICAL FIELD

The present disclosure relates to a method and apparatus for controlling a user interface, and, more particularly, to a method and apparatus for providing and controlling a user interface used to edit a video.

### BACKGROUND ART

Recently, as portable terminals such as smartphones and tablets have been widely spread, performance of these portable terminals has been improved and wireless communication technology has been developed, users can shoot, edit, and share videos using their portable terminals.

However, in portable terminals, due to limitations in the size of a liquid crystal screen and performance of hardware, users cannot smoothly edit videos as in a general PC environment. In order to improve this inconvenience, user demand for a video editing method that can be used in a portable terminal is increasing.

Furthermore, as the needs of users of portable terminals increase, the performances of camera devices, display devices, and hardware of portable terminals are being upgraded, and many functions or services used in PC environments are being performed by portable terminals. In particular, since portable terminals are basically provided with a camera device, user needs for editing images or videos captured through the camera device are increasing.

### DISCLOSURE

### Technical Problem

Due to the resource characteristics of portable terminals, a video editing method has been popularized so that only limited functions can be used, but editing a video at a level similar to that of a PC environment is required.

Meanwhile, when video editing is performed using an input device such as a mouse device or a keyboard device in a PC environment, a user's action for manipulating the input device needs to be accompanied. In the process of manipulating such an input device, the input device is not operated as desired by the user, which may reduce user convenience.

A portable terminal generally includes a display device supporting touch input. When user input is processed through a display device supporting touch input, the user input can be processed more intuitively and user convenience can be remarkably improved.

An object of the present disclosure is to provide an editing user interface (UI) control method and apparatus, which is capable of intuitively processing various functions for video editing in consideration of the above.

In addition, an object of the present disclosure is to provide an editing user interface (UI) control method and apparatus, which is capable of efficiently replacing and editing a specific clip in a video editing project.

An object of the present disclosure is to provide an editing user interface (UI) control method and apparatus, which is capable of replacing a clip included in a project with another clip having a different length and performing editing, when editing a video.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### Technical Solution

According to an aspect of the present disclosure, a video editing UI control method may be provided. The method may include checking an object video clip to be replaced, checking a replaced and input target video clip, controlling a playback speed of the target video clip in consideration of time information of the object video clip and time information of the target video clip, and inserting the controlled target video clip to the playback speed.

The features briefly summarized above with respect to the disclosure are merely exemplary aspects of the detailed description of the disclosure that follows, and do not limit the scope of the disclosure.

### Effects of Invention

According to the present disclosure, it is possible to provide an editing user interface (UI) control method and apparatus, which is capable of efficiently replacing and editing a specific clip in a video editing project.

According to the present disclosure, it is possible to provide an editing user interface (UI) control method and apparatus, which is capable of replacing a clip included in a project with another clip having a different length and performing editing, when editing a video.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a diagram illustrating an electronic device to which various embodiments of the present disclosure are applied.

FIG. 2 is a diagram illustrating a system hierarchy structure of an electronic device to which various embodiments of the present disclosure are applied.

FIG. 3 is a flowchart illustrating a video editing method to which various embodiments of the present disclosure are applied.

FIG. 4 is a diagram illustrating an editing UI provided by a video editing UI control apparatus according to various embodiments of the present disclosure.

FIGS. 5A to 5E are diagrams illustrating a clip editing UI provided by a video editing UI control apparatus according to various embodiments of the present disclosure.

FIG. 6 is a block diagram illustrating a configuration of a video editing UI control apparatus according to various embodiments of the present disclosure.

FIGS. 7A and 7B are diagrams illustrating an operation of controlling an alternative element by an element information management unit included in a video editing UI control apparatus according to an embodiment of the present disclosure.

FIG. 8 is an exemplary diagram illustrating an operation of providing a clip movement control UI by a video editing UI control apparatus according to various embodiments of the present disclosure.

FIG. 9 is another exemplary diagram illustrating an operation of providing a clip movement control UI by a video editing UI control apparatus according to various embodiments of the present disclosure.

### MODE FOR INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

Various embodiments of the present invention may be implemented in an electronic device having a display portion, such as a smartphone, tablet, or the like, and a video editing device according to one embodiment of the present invention may be implemented by an electronic device having a video editing application. Alternatively, it may be implemented by an electronic device having an image processing unit and a control unit capable of processing video and subtitle data.

Preferably, the electronic device to which the various embodiments of the present invention apply is a portable electronic device.

Hereinafter, embodiments of the present disclosure will be described with reference to the accompanying drawings.

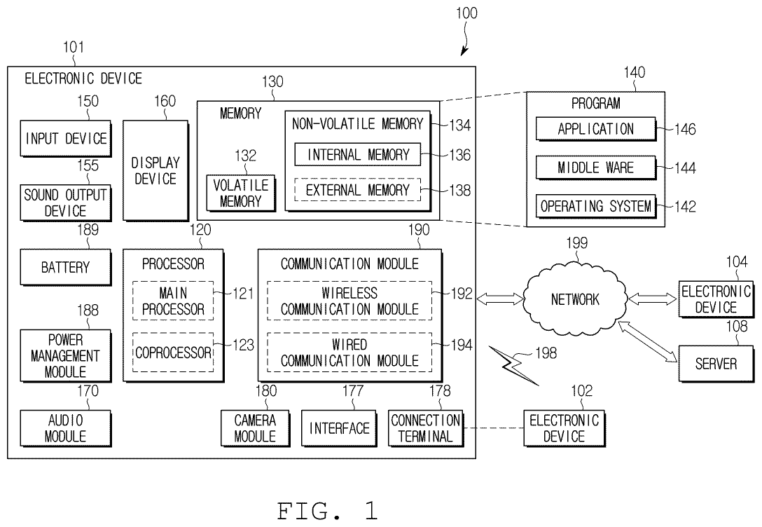

FIG. 1 is a diagram illustrating an electronic device to which various embodiments of the present disclosure are applied.

Referring to FIG. 1, the electronic device 101 in the network environment 100 may communicate with an electronic device 102 through a first network 198 (e.g., short-range wireless communication) or communicate with an electronic device 104 or a server 108 through a second network 199 (e.g., long-range wireless communication). According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, an interface 177, a camera module 180, a power management module 188, a battery 189, and a communication module 190. In some embodiment, the electronic device 101 may omit at least one (e.g., the display device 160 or the camera module 180) of the components or include another component.

The processor 120 may control at least one of the other components (e.g., hardware or software components) of the electronic device 101 connected to the processor 120, for example, by driving software (e.g., a program 140) and perform processing and operation for various data. The processor 120 may process a command or data received from another component (e.g., the communication module 190) by loading the command or data in a volatile memory 132 and store result data in non-volatile memory 134. According to an embodiment, the processor 120 may include a main processor 121 (e.g., a CPU or an application processor) and a coprocessor 123 that is operated independently of it. The coprocessor 123 may be used additionally or alternatively to consume lower power than the main processor 121, or include a coprocessor 123 specialized for a designated function (e.g., a graphic processing device, an image signaling processor, a sensor herb processor, or a communication processor). Herein, the coprocessor 123 may be operated independently of or by being embedded in the main processor 121.

In this case, the coprocessor 123 may control at least some functions or states associated with at least one (e.g., the display device 160 or the communication module 190) of the components of the electronic device 101, together with the main processor 121 while the main processor 121 is in an active (e.g., application operating) state, or instead of the main processor 121 while the main processor 121 is in an inactive (e.g., sleep) state.

According to an embodiment, the coprocessor 123 (e.g., an image signaling processor or a communication processor) may be implemented as a component of another functionally associated component (e.g., the camera module 180 or the communication module 190). The memory 130 may store various data used by at least one component (e.g., the processor 120), that is, input data or output data for software (e.g., the program 140) and a command associated therewith. The memory 130 may include the volatile memory 132 or the non-volatile memory 134.

As software stored in the memory 130, the program 140 may include, for example, an operating system 142, middle ware 144 or an application 146.

The input device 150 is a device for receiving a command or data to be used for a component (e.g., the processor 120) of the electronic device 101 from the outside (e.g., a user) of the electronic device 101. The input device 150 may include a microphone, a mouse or a keyboard.

The sound output device 155 may be a device for outputting an acoustic signal to the outside of the electronic device 101. The sound output device 155 may include, for example, a speaker used for a general purpose like multimedia play or playback and a receiver used exclusively for receiving telephone calls. According to an embodiment, a receiver may be integrated with or separate from a speaker.

The display device 160 may be a device for visually provide a user with information of the electronic device 101. The display device 160 may include, for example, a display, a hologram device, or a projector and a control circuit for controlling the device. According to an embodiment, the display device 160 may include touch circuitry or a pressure sensor capable of measuring a pressure intensity for a touch. Correspondingly, based on touch circuitry or a pressure sensor, the display device 160 may detect a coordinate of a touched input region, the number of touched input regions and a touched input gesture, and provide a detection result to the main processor 121 or the coprocessor 123.

The audio module 170 may bidirectionally convert a sound and an electrical signal. According to an embodiment, the audio module 170 may obtain a sound through the input device 150 or output a sound through the sound output device 155 or an external electronic device (e.g., the electronic device 102 (e.g., a speaker or a headphone)) wired or wirelessly connected to the electronic device 101.

The interface 177 may support a designated protocol capable of wired or wireless connection to an external electronic device (e.g., the electronic device 102). According to an embodiment, the interface 177 may include a high definition multimedia interface (HDMI), a universal serial bus (USB) interface, a SD card or an audio interface.

A connection terminal 178 may include a connected capable of physically connecting the electronic device 101 and an external electronic device (e.g., the electronic device 102), for example, a HDMI connector, a USB connector, a SD card connector or an audio connector (e.g., a headphone connector).

The camera module 180 may shoot a still image and a moving image. According to an embodiment, the camera module 180 may include one or more lenses, an image sensor, an image signal processor or a flash.

The power management module 188 is a module for managing power supplied to the electronic device 101 and may be, for example, a part of a power management integrated circuit (PMIC).

The battery 189 is a device for supplying power to at least one component of the electronic device 101 and may include, for example, a non-rechargeable primary cell, a rechargeable secondary cell or a fuel cell.

The communication module 190 may establish a wired or wireless communication channel between the electronic device 101 and an external electronic device (e.g., the electronic device 102, the electronic device 104, or the server 108) and support the execution of communication through the established communication channel. The communication module 190 may include one or more communication processors that are operated independently of the processor 120 and support wired or wireless communication. According to an embodiment, the communication module 190 may include a wireless communication module 192 (e.g., a cellular communication module, a short-range wireless communication module, or a global navigation satellite system (GNSS)) or a wired communication module 194 (e.g., a local area network (LAN) communication module, or a power line communication module) and communicate with an external electronic device by using a corresponding communication module through a first network 198 (e.g., a short-range communication network like Bluetooth, BLE (Bluetooth Low Energy), WiFi direct or IrDA (Infrared Data Association)) or a second network 199 (e.g., a long-range communication network like a cellular network, the Internet or a computer network (e.g., LAN or WAN)). The various types of communication modules 190 described above may be implemented as a single chip or separate chips respectively.

Among the above components, some components may exchange a signal (e.g., a command or data) by being connected with each other through a communication type (e.g., bus, general purpose input/output (GPIO), serial peripheral interface (SPI)) among peripheral devices or a mobile industry processor interface (MIPI).

According to an embodiment, a command or data may be transmitted or received between the electronic device 101 and the external electronic device 104 through the server 108 connected to the second network 199. Each of the electronic devices 102 and 104 may be a device of a same type as or a different type from the electronic device 101. According to an embodiment, all or some of the operations performed in the electronic device 101 may be performed in another external electronic device or in a plurality of external electronic devices. According to an embodiment, when the electronic device 101 should execute an any function or service either automatically or at a request, the electronic device 101 may request at least some functions associated with the function or service to an external electronic device either additionally or instead of executing the function or service by itself. When receiving the request, the external electronic device may execute the requested function or service and deliver a corresponding result to the electronic device 101. The electronic device 101 may provide the requested function or service by processing the received result either as it is or additionally. To this end, for example, cloud computing technology, distributed computing technology, or client-server computing technology may be used.

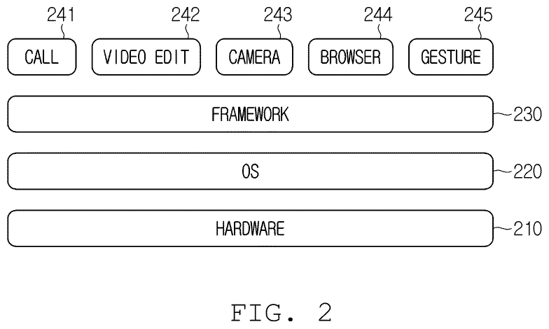

FIG. 2 is a diagram illustrating a system hierarchy structure of an electronic device to which various embodiments of the present disclosure are applied.

Referring to FIG. 2, an electronic device 200 may be configured by including a hardware layer 201 corresponding to the electronic device 100 of FIG. 1, an operating system (OS) layer 200 as an upper layer of the hardware layer 210 for managing the hardware layer 210, and a framework layer 230 and an application layer 240 as upper layers of the OS layer 220.

The OS layer 220 performs functions to control the overall operation of the hardware layer 210 and manage the hardware layer 210. That is, the OS layer 220 is a layer executing basic functions including hardware management, memory and security. The OS layer 220 may include a display driver for driving a display device, a camera driver for driving a camera module, an audio driver for driving an audio module and any similar driver for operating or driving a hardware device installed in an electronic device. In addition, the OS layer 220 may include a runtime and a library accessible to a developer.

There is the framework layer 230 as an upper layer of the OS layer 220, and the framework layer 230 performs a role of linking the application layer 240 and the OS layer 220. That is, the framework layer 230 includes a location manager, a notification manager and a frame buffer for displaying a video on a display unit.

The application layer 240 for implementing various functions of the electronic device 100 is located in an upper layer of the framework layer 230. For example, the application layer 240 may include various application programs like a call application 241, a video editing application 242, a camera application 243, a browser application 244, and a gesture application 245.

Furthermore, the OS layer 220 may provide a menu or UI capable of adding or deleting at least one application or application program included in the application layer 240 and thus at least one application or application program included in the application layer 240 may be added or deleted by a user. For example, as described above, the electronic device 100 of FIG. 1 may be connected to another electronic device 102 and 104 or the server 108 via communication. At a user's request, the electronic device 100 may receive and store data (that is, at least one application or application program) from the another electronic device 102 and 104 or the server 108 and include the data in a memory. Herein, the at least one application or application program stored in the memory may be configured and operated in the application layer 240. In addition, at least one application or application program may be selected by a user through a menu or UI provided by the OS layer 220. The at least one application or application program thus selected may be deleted.

Meanwhile, when a user control command input through the application layer 240 is input into the electronic device 100, as the input control command is delivered from the application layer 240 to the hardware layer 210, a specific application corresponding to the command may be implemented and a corresponding result may be displayed in the display device 160.

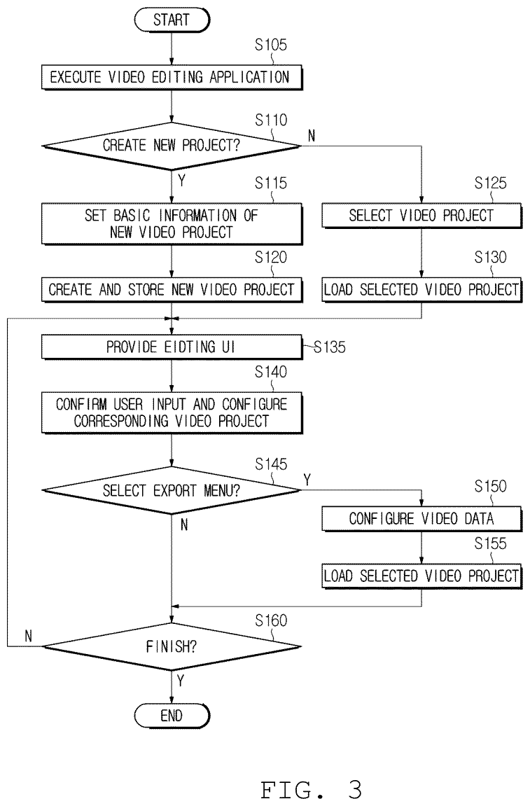

FIG. 3 is a flowchart illustrating a video editing method to which various embodiments of the present disclosure are applied.

Referring to FIG. 3, first, a video editing method may be implemented by the above-described electronic device, and the implementation may start, when a video editing application is selected and implemented by a user input (S105).

When the video editing application is executed, the electronic device may output an initial screen of the video editing application to a display device (e.g., display). An initial screen may provide a menu (or UI) for creating a new video project and a video project selection menu (or UI) for selecting a video project already being edited. In such an initial screen, when a menu (or UI) for creating a new video project is selected, the step S115 may be performed, and when a video project selection menu (or UI) is selected, the step S125 may be performed (S110).

At step S115, the electronic device may provide a menu (or UI) for setting basic information of a new video project and set and apply the basic information input through the menu (UI) to the new video project. For example, basic information may include a screen ratio of a new video project. Based on this, the electronic device may provide a menu (or UI) for selecting a screen ratio like 16:9, 9:16 and 1:1 and set and apply a screen ratio input through the menu (UI) to a new video project.

Next, by reflecting basic information set in step S115, the electronic device may create a new video project and store the new video project thus created in a storing medium (S120).

Although an embodiment of the present disclosure presents an example screen ratio as basic information, the present disclosure is not limited to the embodiment, which may be modified in various ways by those skilled in the art. For example, an electronic device may provide a menu (or UI) for setting at least one of the automatic control of master volume, a master volume size, a basic audio fade-in setting, a basic audio fade-out setting, a basic video fade-in setting, a basic video fade-out setting, a basic setting of an image clip, a basic setting of a layer length, and basic settings of image clip pan & zoom. The electronic device may set a value input through the menu (or UI) as basic information of a new video project.

For another example, an electronic device may automatically set predetermined values for automatic control of master volume, a master volume size, a basic audio fade-in setting, a basic audio fade-out setting, a basic video fade-in setting, a basic video fade-out setting, a basic setting of an image clip, a basic setting of a layer length, and basic settings of image clip pan & zoom. In addition, an electronic device may provide a setting menu (or UI) and receive inputs of control values for automatic control of master volume, a master volume size, a basic audio fade-in setting, a basic audio fade-out setting, a basic video fade-in setting, a basic video fade-out setting, a basic setting of an image clip, a basic setting of a layer length, and basic settings of image clip pan & zoom. The electronic device may also set the above-described basic information according to the input values.

Meanwhile, at step S115, the electronic device may provide a project list including a video project stored in the storing medium and an environment in which at least one video project included in the project list may be selected. Through the above-described environment, a user may select at least one video project included in the project list, and the electronic device may load at least one video project selected by the user (S130).

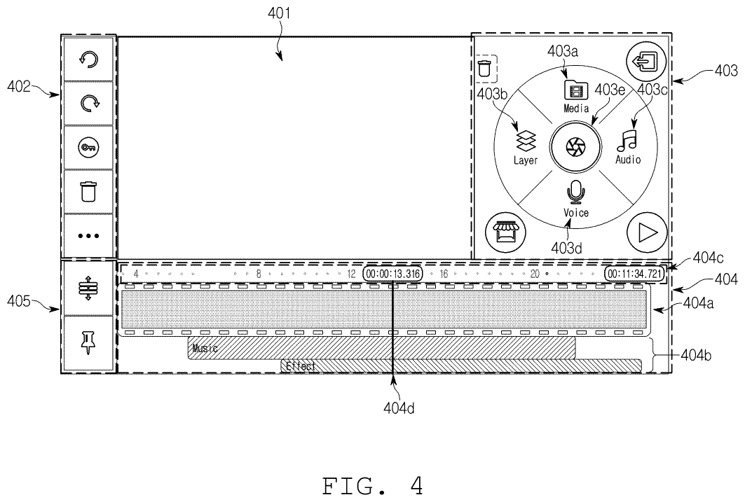

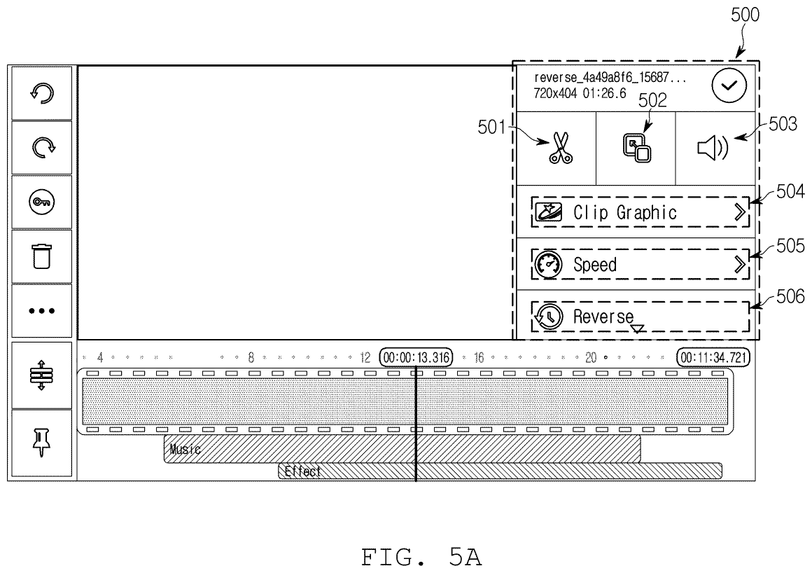

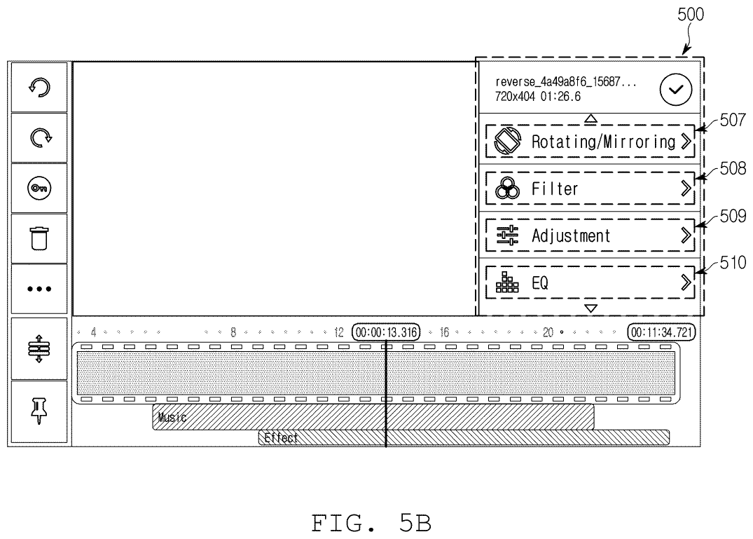

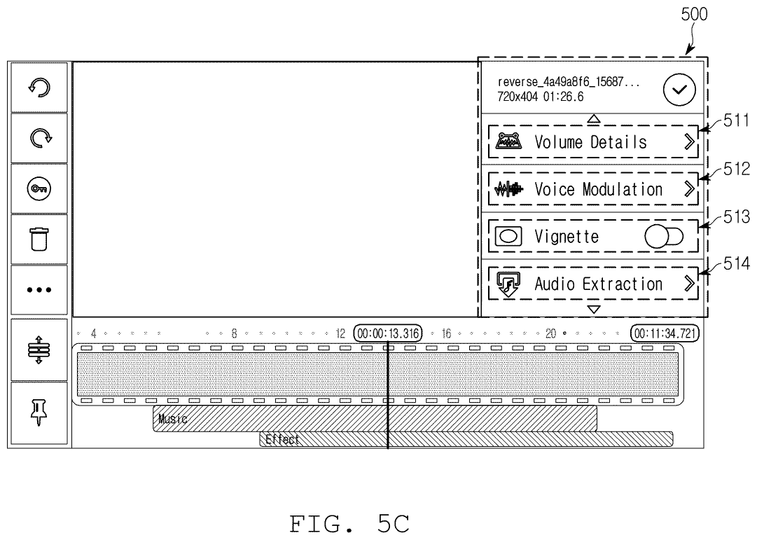

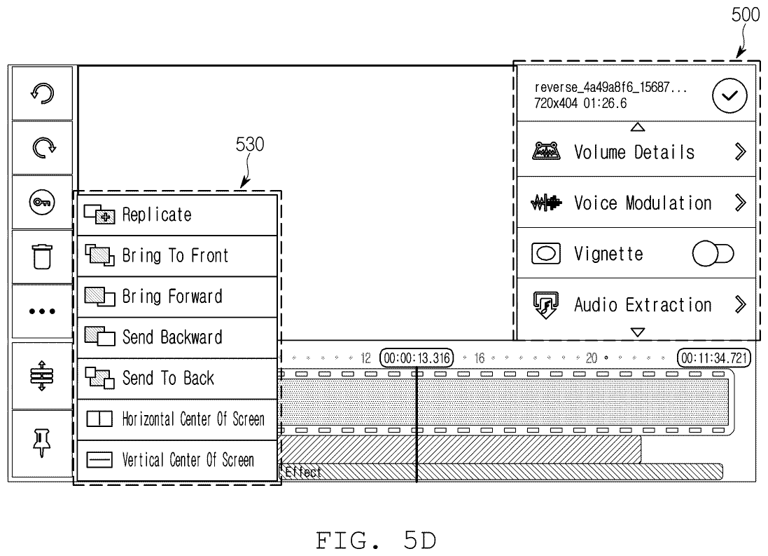

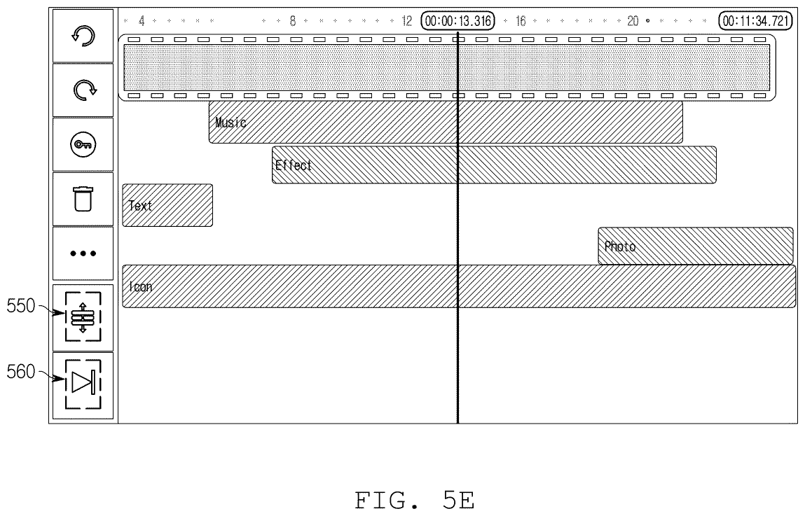

At step S135, the electronic device may provide an editing UI. As exemplified in FIG. 4, the editing UI may include a video display window 401, a media setting window 402, a media input window 403, a clip display window 404, and a clip setting window 405. In an editing UI, a video display window, a media setting window and a media input window may appear in the upper part of the display, while a clip display window and a clip setting window may appear in the lower part of the display.

The media setting window may include an export menu, a capture menu and a setting menu, and the export menu, the capture menu and the setting menu may be provided in forms of icon or text enabling these menus to be recognized.

The media input window may include a media input menu 403A, a layer input menu 403B, an audio input menu 403C, a voice input menu 403D and a shooting menu 403E. The media input menu 403A, the layer input menu 403B, the audio input menu 403C, the voice input menu 403D and the shooting menu 403E may be provided in forms of icon or text enabling these menus to be recognized. In addition, each menu may include a sub-menu. When each menu is selected, the electronic device may configure and display a corresponding sub-menu.

For example, the media input menu 403A may be connected to a media selection window as a sub-menu, and the media selection window may provide an environment in which media stored in a storing medium can be selected. The media selected through the media selection window may be inserted into and displayed in a clip display window. The electronic device may confirm a type of media selected through the media selection window, and it may set a clip time of the media and insert and display the clip time in the clip display window by considering the confirmed type of media. Here, the type of media may include an image, a video and the like. When the type of media is an image, the electronic device may confirm a basic set value of length of an image clip and set an image clip time according to the basic set value of length of the image clip. In addition, when the type of media is a video, the electronic device may set a video clip time according to a length of the medium.

The layer input menu 403B may include, as sub-menus, a media input menu, an effect input menu, an overlay input menu, a text input menu, a media input menu, and a drawing input menu.

A media input menu may be configured in a same way as the above-described media input menu.

An effect input menu may provide an environment to select a blurring effect, a mosaic effect, a noise effect, a sandstorm effect, a melting point effect, a crystal effect, a star filter effect, a display board effect, a haze effect, a fisheye lens effect, a magnifying lens effect, a flower twist effect, a night vision goggle effect, and a sketch effect. An effect selected through the effect input menu may be inserted and displayed in a clip display window. Herein, an electronic device may confirm a basic set value of layer length and set an effect clip time according to the basic set value of layer length.

An overlay input menu may provide an environment to select various forms or shapes of stickers and icons. A sticker and an icon selected through the overlay input menu may be inserted and displayed in a clip display window. Herein, an electronic device may confirm a basic set value of layer length and set clip time for sticker, icon and the like according to the basic set value of layer length.

A text input menu may provide an environment to input a text, that is, a QWERTY keyboard. A text selected through the text input menu may be inserted and displayed in a clip display window. Herein, an electronic device may confirm a basic set value of layer length and set a text clip time according to the basic set value of layer length.

A drawing input menu may provide a drawing area to a video display window and be configured such that a drawing object is displayed in a touch input area of the video display window. A handwriting input menu may include, as sub-menus, a drawing tool selection menu for selecting a drawing tool, a color selection menu for selecting a drawing color, a thickness setting menu for setting thickness of a drawing object, a partial delete menu for deleting a created drawing object, and an entire delete menu for deleting an entire object that has been drawn. In addition, when a handwriting input menu is selected, an electronic device may confirm a basic set value of layer length and set a drawing object clip time according to the basic set value of layer length.

The audio input menu 403C may be connected to an audio selection window as a sub-menu, and the audio selection window may provide an environment to select an audio file stored in a storage medium. An audio file selected through the audio selection window may be inserted and displayed in a clip display window.

The voice input menu 403d may be a menu for recording a sound input through a microphone. When the voice input menu is selected by the user, an electronic device may detect an audio signal input through a microphone by activating the microphone included in the electronic device. In addition, the electronic device may show a start recording button. When the start recording button is input, audio signals may start being recorded. Furthermore, the electronic device may visually display audio signals input through the microphone. For example, the electronic device may confirm a size or frequency feature of an audio signal and display the feature thus confirmed in a form of level meter or graph.

The shooting menu 403E may be a menu for shooting an image or a video that is input through a camera module provided in an electronic device. The shooting menu 403E may be shown by an icon or the like visualizing a camera device. The shooting menu 403E may include an image/video shooting selection menu, as a sub-menu, for selecting a camera for capturing an image or a camcorder for shooting a video. Based on this, when the shooting menu 403e is selected by the user, the electronic device may display the image/video shooting selection menu. In addition, the electronic device may activate an image shooting mode or a video shooting mode of a camera module according to what is selected through the image/video shooting selection menu.

The clip display window 404 may include at least one clip line for displaying clips corresponding to media, effects, overlays, texts, drawings, audio or speech signals that are input through the media input window.

A clip line may include a main clip line 404a and a sub clip line 404b. The main clip line 404a may be a clip line provided at the top of a clip display window, and the sub clip line 404b may be at least one clip line provided below the main clip line 404a.

An electronic device may display the main clip line 404a by fixing the main clip line 404a at the top of a clip display window. The electronic device may confirm a drag input in an area, in which the sub clip line 404b exists, and display the sub clip line 404b by scrolling the sub clip line 404b up and down in response to a direction of the drag input.

Furthermore, when the direction of the drag input is an upward direction, the electronic device may display the sub clip line 404b by moving the sub clip line 404b to an upper area, and when the direction of the drag input is a downward direction, the electronic device may display the sub clip line 404b by moving the sub clip line 404b to a lower area. In addition, the electronic device may differently display the vertical width of the main clip line 404b in response to the movement of the sub clip line 404b. For example, when the sub clip line 404b moves upwards, the vertical width of the main clip line 404a may be decreased to be displayed, and when the sub clip line 404b moves downwards, the vertical width of the main clip line 404a may be increased to be displayed.

In particular, a clip display window may include a time display line 404c for indicating a time of a video project and a play head 404d. The time display line 404c may be displayed on top of the main clip line 404a described above and include figures or ticks in predetermined units. In addition, the play head 404d may be displayed as a vertical line starting from the time display line 404c to the bottom of the clip display window, and the play head 404d may be shown in a color (e.g., red) that may be easily recognized by the user.

Furthermore, the play head 404d may be provided with a fixed form in a predetermined area, and objects included in the main clip line 404a and the sub clip line 404b and the time display line 404c, which are provided in the clip display window, may be so configured as to move horizontally.

For example, when a drag input occurs in the left and right direction in an area in which the main clip line 404a, the sub clip line 404b and the time display line 404c are located, the electronic device may move objects included in the main clip line 404a and the sub clip line 404b and the time display line 404c in the left and right direction and display them. Herein, the electronic device may configure a frame or an object corresponding to the play head 404d so as to be displayed in the video display window. Also, the electronic device 404d may confirm a detailed time (e.g., 1/1000 second unit), in which the play head is touched, and also display the confirmed detailed time in the clip display window.

In addition, the electronic device may check whether or not multiple touches occur in the clip display window, and when multiple touches occur, the electronic device may respond to the multiple touches by changing and displaying a tick or figure in a predetermined unit included in the time display line 404c. For example, when an input is detected with a gradually decreasing interval of multiple touches, the electronic device may decrease an interval of the tick or figure. When an input is detected with a gradually increasing interval of multiple touches, the electronic device may display the tick or figure by increasing the interval of the tick or figure.

The electronic device may configure the clip display window 404 such that a clip displayed in a clip line can be selected, and when the clip is selected, the electronic device may visually show that the clip is selected. For example, when the electronic device detects that a clip is selected, the electronic device may provide a predetermined color, for example, yellow to a boundary of the selected clip.

Preferably, when it is detected that a clip is selected, the electronic device may provide a clip editing UI capable of editing the selected clip. For example, the electronic device may display a clip editing UI in an area where the media input window 403 exists. A clip editing UI may be differently set according to the type of a selected clip. Specifically, when a type of a clip is a video clip, the electronic device configure and provide a clip editing UI 500 by including a trim/split menu 501, a pan/zoom menu 502, an audio control menu 503, a clip graphics menu 504, a speed control menu 505, a reverse control menu 506, a rotation/mirroring control menu 507, a filter menu 508, a brightness/contrast adjustment menu 509, a voice EQ control menu 510, a detailed volume control menu 511, a voice modulation menu 512, a vignette control menu 513, and an audio extraction menu 514.

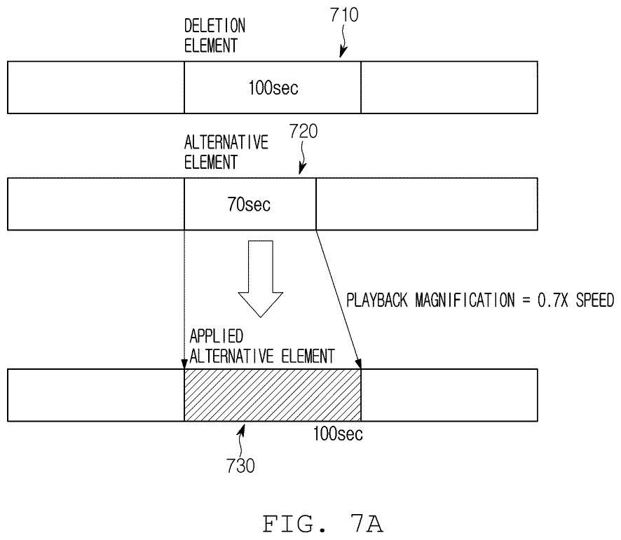

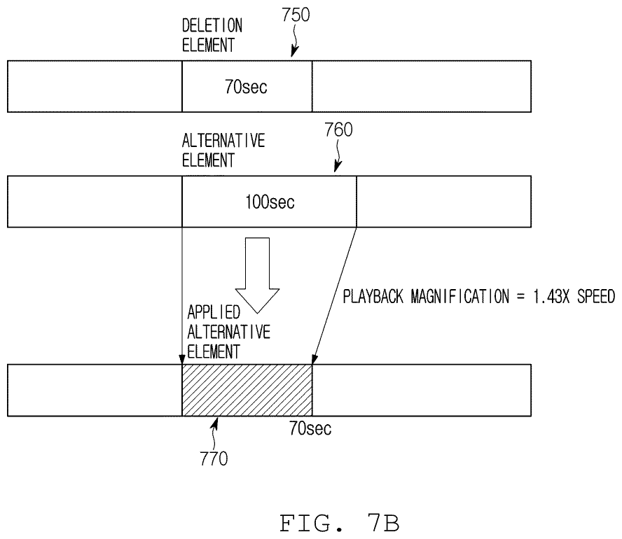

A clip editing UI for each clip type may be configured based on a structure of a video editing UI of FIGS. 7a through 7g below and the configuration of the clip editing UI refers to the disclosures of FIGS. 7a through 7g.

In addition, the electronic device may further display a clip editing expansion UI 530 in an area in which a media setting window exists. A clip editing expansion UI displayed in an area of media setting window may be also differently set according to a type of a selected clip. For example, when a type of clip is a video clip, an image clip, an audio clip or a voice signal clip, the electronic device may configure and provide the clip editing expansion UI 530 including a clip delete menu, a clip copy menu and a clip layer copy menu, and when a type of clip is an effect clip, a text clip, an overlay clip or a drawing clip, the electronic device may configure and provide the clip editing expansion UI including a clip delete menu, a clip copy menu, a bring to front menu, a bring forward menu, a send backward menu, a send to back menu, a horizontal center alignment menu, and a vertical center alignment.

A clip setting window may include a clip expansion display menu 550 and a clip movement control menu 560. When the clip expansion display menu 550 is selected by the user, the electronic device may display a clip display window by expanding the window to the entire area of display. In addition, when the clip movement control menu 560 is selected, the electronic device may display a clip by moving the clip to a play head. Furthermore, the clip movement control menu 560 may include a start area movement menu or an end area movement menu, and the start area movement menu or the end area movement menu may be preferably displayed adaptively by considering the position of a play head touching a clip. For example, the electronic device may basically provide the start area movement menu, and when a clip touches the start position of a play head, the electronic device may display replace the end area movement menu in replacement of the start area movement menu.

At step S140, the electronic device may confirm a user input that is input through an editing UI, configure a corresponding video project and store the configured video project in a storage medium.

As described above, an editing UI may be configured to include an export menu in a media setting window, and when the export menu is selected by the user (Y of S145), the electronic device may configure video data by reflecting information that is configured in a video project and store the video data in a storage medium (S150).

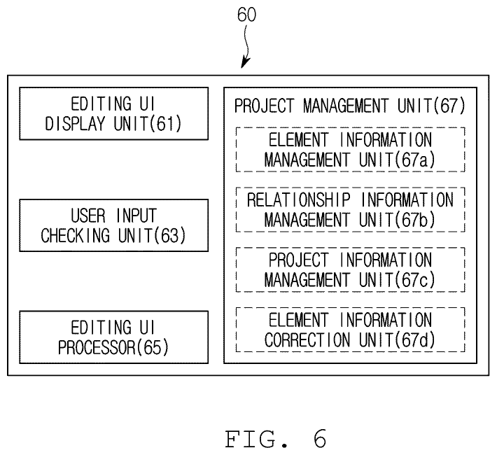

FIG. 6 is a block diagram illustrating a configuration of a video editing UI control apparatus according to various embodiments of the present disclosure.

Referring to FIG. 6, the video editing UI control apparatus 60 according to various embodiments of the present disclosure may include an editing display unit 61, a user input checking unit 63, an editing UI processor 65 and a project management unit 67.

The editing UI display unit 61 may visualize and display the above-mentioned editing UI on a display device (e.g., a display) and, more particularly, may check a menu or UI, output of which is requested by the editing UI processor 65, and display it on the display device (e.g., the display). Here, the editing UI may include at least one menu or UI having a predetermined shape and size, and may be configured such that at least one menu or UI is located and displayed in a predetermined area.

The user input checking unit 63 may check user input information such as user input occurrence coordinates, types of user input (e.g., single-touch input, multi-touch input, single-gesture input, multi-gesture input, etc.) or gesture (single- or multi-gesture) input direction based on coordinates of a touch input area, the number of touch input areas, a touch input gesture, etc. provided through the aforementioned display device 160 (see FIG. 1), and provide the checked user input information to the editing UI processor 65.

The editing UI processor 65 may check user input information provided by the user input checking unit 63 and process an operation corresponding to the user input information. For example, the editing UI processor 65 may check the user input occurrence coordinates and process an operation corresponding to a menu or UI corresponding to the checked coordinates. As another example, the editing UI processor 65 may check a sub-menu or sub-UI of a menu or UI corresponding to the checked coordinates, and request output of the checked sub-menu or sub-UI from the editing UI display unit 61.

Also, the editing UI processor 65 may be associated with the project management unit 67, and may perform editing using information provided from the project management unit 67. The editing UI processor 65 may check that at least one clip included in a clip display window 404 is selected, and provide an editing UI or menu suitable for the type of the selected clip. For example, the editing UI processor 65 may provide an editing UI for modifying or deleting a clip as a clip included in the clip display window 404 is selected.

The editing UI processor 65 may provide an editing UI for replacing the clip, as a clip included in the clip display window 404 is selected. When an editing UI for replacing the clip may be provided and a UI or menu requesting clip replacement is selected by a user, a menu for selecting a clip to be replaced may be provided. For example, the menu for selecting the clip to be replaced may include a clip list display window displaying at least one clip list. At this time, the list displayed on the clip list display window may be requested and received from the project management unit 67. Furthermore, as at least one clip is selected through the clip list display window, the editing UI processor 65 may insert the selected clip into a corresponding section.

Meanwhile, a video may be configured by combining at least one element, and a combination of at least one element may be managed as a project. For example, the project may be configured by combining information on at least one element and information on a relationship between the at least one element. Here, at least one element includes a clip inserted into a video, and specifically, may include a video clip, an image clip, an audio clip, a voice signal clip, an effect clip, a text clip, an overlay clip, a drawing clip, and the like. In consideration of the foregoing, the project management unit 67 may combine information on at least one element (hereinafter referred to as element information) and information on a relationship between at least one element (hereinafter referred to as relationship information) to configure project information.

Specifically, the project management unit 67 may include an element information management unit 67a, a relationship information management unit 67b, a project information management unit 67c, and an element information correction unit 67d.

The element information management unit 67a may be a component that checks and manages element information. Element information may include identifiers of elements included in a project, element types (or clip type), element detailed information, and the like. Here, the element types may include a video clip, an image clip, an audio clip, a voice signal clip, an effect clip, a text clip, an overlay clip, a drawing clip, and the like. Furthermore, when the element type is an element of a property that is changed and played back over time, such as a video clip, an audio clip, a voice signal clip, etc., the element information may further include information on a speed at which the element is played back, that is, playback speed information.

The relationship information management unit 67b may be a component that checks and manages relationship information. The relationship information may include information on the order of elements included in a project, start and end points of elements, spatial locations of elements, and hierarchical relationships of elements.

The project information management unit 67c may be a component that checks and manages project information. The project information may include a project identifier, element information, relationship information, and the like.

The element information correction unit 67d may process an operation of replacing at least one element selected by the editing UI processor 65 with another element. For example, at least one element may be selected through the editing UI processor 65, and an operation of deleting the selected element and replacing it with another element in a corresponding section may be checked. In response thereto, the element information correction unit 67d may check element information of an element to be deleted (hereinafter referred to as a deletion element) and element information of an element to be replaced (hereinafter referred to as an alternative element), and, particularly, may check the element types of the deletion element and the alternative element. If the type of element is an element that is changed and played back over time, such as a video clip, an audio clip, a voice signal clip, etc., the element information correction unit 67d may check section length information of the deletion element and the alternative element and playback speed information. In addition, the element information correction unit 67d may allocate the alternative element to a corresponding section according to section length information of the deletion element and the alternative element.

Furthermore, in allocating an alternative element to a section of the deletion element, the section lengths of the deletion element and the alternative element may be configured to be different from each other. Accordingly, the element information correction unit 67d may adjust the length of the alternative element according to the section length information of the deletion element and the alternative element. For example, when the section length of the alternative element is relatively longer than that of the deletion element, some sections of the alternative element may be cut out to adjust the section length. For example, in order to cut out the front end or the rear end of the alternative element according to the section length of the deletion element, the element information correction unit 67d may provide a menu for selecting a section to be cut out and check the section to be cut out through user input. The element information correction unit 67d may cut out the checked section and allocate the alternative element to the corresponding section.

On the other hand, when the section length of the alternative element is relatively shorter than that of the deletion element, it is necessary to fill the section that is not filled using the alternative element. In order to fill the section that is not filled using the alternative element, a dummy element of a specific color (e.g., black color) is inserted, an alternative element is repeatedly inserted, or specific information (e.g., hatched clip, etc.) is inserted. However, in case of insertion of meaningless elements such as insertion of the dummy element, repeated insertion of the alternative element, or insertion of the hatched clip, etc., the overall editing is synchronized within the project, but the editing results may be unsatisfactory or meaningless elements may be processed. Considering the foregoing, when the section length of the alternative element is relatively shorter than that of the deletion element, the element information correction unit 67d may correct the alternative element to match the section length of the deletion element and insert it. For example, the element information correction unit 67d may configure an alternative element by controlling playback speed information of the alternative element, and insert it. Specifically, when the section length of a deletion element (e.g., a video clip) is 10 seconds and the section length of an alternative element (e.g., a video clip) replacing it is 5 seconds, the element information correction unit 67d may set the section length to 10 seconds by controlling the playback speed of the alternative element (e.g., the video clip) to ½ speed.

In this way, when an alternative element (e.g., a video clip) is inserted into a section of a deletion element (e.g., a video clip) by controlling the playback speed thereof, content with a relatively high level of satisfaction may be configured compared to a conventional method of inserting a dummy clip of a specific color or repeatedly playing back an alternative element (e.g., a video clip).

In particular, since there is little awkwardness due to double speed while solving the above-described problem, the effect may be greater as a difference between the lengths of the deletion element (e.g., a video clip) and the alternative element (e.g., a video clip) is not large.

As another example, it may be applied even when the length of the alternative element (e.g., the video clip) is relatively longer than that of the deletion element (e.g., the video clip). That is, instead of cutting out some sections of the alternative element (e.g., the video clip), the element information correction unit 67d may be configured to control the playback speed of the alternative element (e.g., the video clip) to be 1× or higher and insert the alternative element (e.g., the video clip) with a relatively high speed.

Furthermore, the element information correction unit 67d may be configured to set a threshold for the calculated playback speed and not to apply playback speed adjustment when the playback speed exceeds the threshold.

FIGS. 7A and 7B are diagrams illustrating an operation of controlling an alternative element by an element information management unit included in a video editing UI control apparatus according to an embodiment of the present disclosure.

Referring to FIG. 7A, an operation of controlling a playback magnification of an alternative element 720 using a deletion element 710 and an alternative element 720 included in a project is illustrated. For example, when the section length Length_Ref of the deletion element 710 is 100 seconds and the section length Length_Alt of the alternative element 720 is 70 seconds, the element information correction unit 67d may calculate the playback magnification as 0.7 through the operation of Equation 1 below. In addition, the element information correction unit 67d may apply a playback magnification of 0.7× speed to the alternative element 720 to configure an applied alternative element 730 and apply it to a corresponding section.

$$playback speed = \frac{{Length}_{Alt}}{{Length}_{Ref}} \qquad [ Equation 1 ]$$

Referring to FIG. 7B, an operation of controlling the playback magnification of an alternative element 760 using a deletion element 750 and an alternative element 750 included in a project is illustrated. For example, when the section length Length_Ref of the deletion element 750 is 70 seconds and the section length Length_Alt of the alternative element 726 is 100 seconds, the element information correction unit 67d may calculate a playback magnification as 1.43 through the operation of Equation 1 above. In addition, the element information correction unit 67d may apply a playback magnification of 1.43× speed to the alternative element 760 to configure an applied alternative element 770 and apply it to a corresponding section.

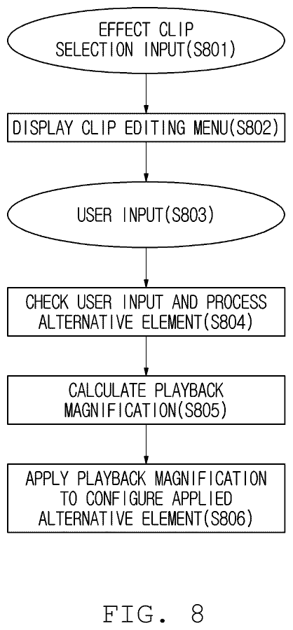

FIG. 8 is an exemplary diagram illustrating an operation of providing a clip movement control UI by a video editing UI control apparatus according to various embodiments of the present disclosure.

First, the video editing UI control apparatus may provide a video editing UI including a video display window, a media setting window, a media input window, a clip display window, a clip setting window, and the like, and at least one clip included in the clip display window may be selected. (S801). For example, the video editing UI control apparatus may check that a video clip has been selected, as touch input is generated in an area where a video clip is present among a plurality of clips displayed in the clip display window for a predetermined time (e.g., 1 second).

Accordingly, the video editing UI control apparatus may check a UI for editing a video clip, that is, a video clip editing menu, and display the video clip editing menu in an area where a media input window is present (S802).

Thereafter, the video editing UI control apparatus may check user input occurred in the video clip editing menu (S803) and process an operation corresponding thereto (S804). In particular, the video clip editing menu may include a menu for selecting an alternative element. For example, a menu for selecting an alternative element may include an alternative element selection button, and as the alternative element selection button is selected, a file explorer or the like may be activated, and the selected alternative element may be checked through the file explorer or the like.

As an example, a case in which the section length Length_Ref of the deletion element 710 (see FIG. 7A) is 100 seconds and the section length Length_Alt of the alternative element 720 is 70 seconds is illustrated. Accordingly, the video editing UI control apparatus calculates the playback magnification through the operation of Equation 1 (S805).

Then, the video editing UI control apparatus may apply the calculated playback magnification, that is, 0.7× speed, to the alternative element 720 to configure the applied alternative element 730 and apply it to a corresponding section (S806).

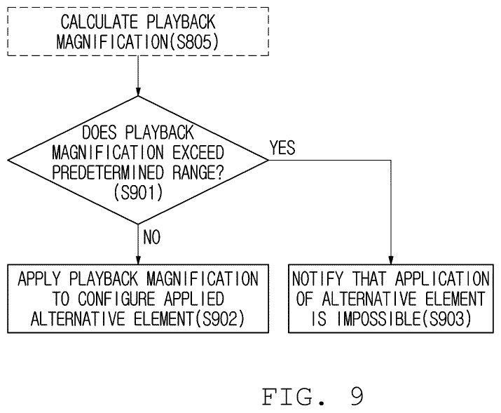

Furthermore, the video editing UI control apparatus may check whether the calculated playback magnification exceeds a predetermined threshold range, in applying the playback magnification to the alternative element. In addition, the video editing UI control apparatus may be configured not to apply insertion by speed adjustment when the calculated playback magnification exceeds the threshold range. Specifically, referring to FIG. 9, the video editing UI control apparatus compares the calculated playback magnification with a predetermined threshold value to determine whether the calculated playback magnification exceeds the predetermined threshold range (S901). If the calculated playback magnification does not exceed the predetermined threshold range, the video editing UI control apparatus may apply the calculated playback magnification to an alternative element to configure an applied alternative element, and apply it to a corresponding section (S902). On the other hand, when the calculated playback magnification exceeds the predetermined threshold range, the video editing UI control apparatus may display a message notifying that application of the alternative element is impossible (S903). For example, when the calculated playback magnification is less than 0.5 or greater than 1.5, the video editing UI control apparatus may determine that it exceeds the predetermined threshold range.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A video editing user interface (UI) control apparatus, comprising:
an editing UI display configured to visualize and display an editing UI on a display device;
a user input checking unit configured to check user input information based on user touch input provided through the display device; and
an editing UI processor configured to check a deletion element based on the user input information provided by the user input checking unit, to check a type of the selected deletion element, to check an alternative element in consideration of time information of the selected deletion element and to control and apply the alternative element.

2. The video editing UI control apparatus of claim 1, wherein the editing UI processor is configured to:
check section length information of the deletion element,
check section length information of the alternative element, and
set a section length of the alternative element to match a section length of the deletion element.

3. The video editing UI control apparatus of claim 1, wherein the editing UI processor is configured to:
check section length information of the deletion element,
check section length information of the alternative element, and
control a playback speed of the alternative element according to a section length of the deletion element.

4. The video editing UI control apparatus of claim 3, wherein the editing UI processor is configured to calculate a playback speed of the alternative element through an operation of Equation 1 below:
$$playback speed = \frac{{Length}_{Alt}}{{Length}_{Ref}} \qquad [ Equation 1 ]$$
where, Length_Ref denotes a section length of the deletion element, and Length_Alt denotes a section length of the alternative element.

5. The video editing UI control apparatus of claim 3, wherein the editing UI processor is configured to compare the playback speed of the alternative element with a predetermined threshold range and to determine whether to apply the alternative element according to a result of comparison.

6. The video editing UI control apparatus of claim 3, wherein the editing UI processor is configured to:
compare the playback speed of the alternative element with a predetermined threshold range,
apply the playback speed to the alternative element, in response to the playback speed of the alternative element being in the predetermined threshold range.

7. The video editing UI control apparatus of claim 6, wherein the editing UI processor is configured to:
compare the playback speed of the alternative element with a predetermined threshold range,
determine that application of the alternative element is impossible, in response to the playback speed of the alternative element exceeding the predetermined threshold range.

8. A video editing user interface (UI) control method comprising:
visualizing and displaying an editing UI on a display device;
checking user input information based on user touch input provided through the display device;
checking the user input information and checking a deletion element based on the user input information;
checking a type of the selected deletion element; and
checking an alternative element in consideration of time information of the selected deletion element and controlling and applying the alternative element.

9. The video editing UI control method of claim 8, wherein the controlling and applying the alternative element comprises:
checking section length information of the deletion element,
checking section length information of the alternative element, and
setting a section length of the alternative element to match a section length of the deletion element.

10. The video editing UI control method of claim 8, wherein the controlling and applying the alternative element comprises:
checking section length information of the deletion element,
checking section length information of the alternative element, and
controlling a playback speed of the alternative element according to a section length of the deletion element.

11. The video editing UI control method of claim 10, wherein the controlling and applying the alternative element comprises calculating a playback speed of the alternative element through an operation of Equation 1 below:
$$playback speed = \frac{{Length}_{Alt}}{{Length}_{Ref}} \qquad [ Equation 1 ]$$
where, Length_Ref denotes a section length of the deletion element, and Length_Alt denotes a section length of the alternative element.

12. The video editing UI control method of claim 10, wherein the controlling and applying the alternative element comprises:
comparing the playback speed of the alternative element with a predetermined threshold range; and
determining whether to apply the alternative element according to a result of comparison.

13. The video editing UI control method of claim 10, wherein the controlling and applying the alternative element comprises:
comparing the playback speed of the alternative element with a predetermined threshold range,
applying the playback speed to the alternative element, in response to the playback speed of the alternative element being in the predetermined threshold range.

14. The video editing UI control method of claim 13, wherein the controlling and applying the alternative element comprises:
comparing the playback speed of the alternative element with a predetermined threshold range,
determining that application of the alternative element is impossible, in response to the playback speed of the alternative element exceeding the predetermined threshold range.

15. The video editing UI control method of claim 8, wherein the type of the element comprises an element having a property changed and played back over time.
